(19) United States
(12) Patent Application Publication
(10) Pub. No.: US 2025/0294645 A1
(43) Pub. Date: Sep. 18, 2025

(54) HEATING ASSEMBLY

(71) Applicant: Honeywell International Inc., Charlotte, NC (US)

(72) Inventors: Mehrad Mehr, Morristown, NJ (US); Bahram Jadidian, Watchung, NJ (US)

(21) Appl. No.: 18/602,728

(22) Filed: Mar. 12, 2024

(51) Int. Cl. H05B 3/14; H05B 3/62

(52) U.S. Cl. CPC H05B 3/145; H05B 3/62; H05B 2203/007; H05B 2203/017; H05B 2203/022

(57) ABSTRACT

In some examples, a heating assembly includes at least two electrical connectors and at least one heating module extending between the at least two electrical connectors. Each heating module is monolithic, includes graphite, and is configured to expand in a first direction and remain rigid in a second direction that is substantially perpendicular to the first direction.

### GOVERNMENT RIGHTS

This invention was made with Government support under Grant Contract Number 80MSFC21CA010 awarded by NASA. The Government has certain rights in the invention.

### TECHNICAL FIELD

The present disclosure relates to devices, systems, and techniques for heating.

### BACKGROUND

Various thermal process systems, such as reactors and heat treatment vessels, generate heat in a heating assembly and transfer heat from the heating assembly to a process gas or a substrate in the thermal process system. Some thermal process systems operate at relatively high temperatures, and the heating assembly may operate at even higher temperatures to produce an adequate temperature difference for quickly heating a process gas or substrate. For example, methane pyrolysis occurs at a relatively high temperature, and methane pyrolysis reactors may use large amounts of power to heat the methane to a pyrolysis temperature.

### SUMMARY

In general, the disclosure describes heating assemblies, including methods of manufacture, that include one or more high temperature heating modules configured to efficiently heat a thermal process system with reduced mechanical strain. A heating assembly includes at least two electrical connectors configured to receive power and at least one heating module between the electrical connectors. Each heating module is monolithic, thereby reducing material interfaces that may otherwise create thermal stresses or electrical discontinuities. Each heating module includes graphite, which has a relatively high electrical conductivity compared to other non-metallic heating elements. Despite the relatively high electrical conductivity, a heating module may include elongated sections having a relatively small cross-section, and a corresponding high resistance, suitable for efficiently generating thermal energy sufficient to heat the thermal process system to a desired temperature. For example, resource limited environments may have a limited availability of power and/or only high voltage, low current power, such that heating assemblies formed from graphite having a relatively small cross-section may generate sufficient heat for a given power level for which heating assemblies formed from ceramic materials may not be capable.

In addition to efficiently heating the thermal process system, in some examples, the heating assembly is configured to accommodate thermal expansion and contraction of adjacent components of the thermal process system, such as a vessel or housing in contact or close proximity to the heating assembly. In some examples, each heating module is configured to expand in a first direction, such as away from an axis of the thermal process system, and remain rigid in a second direction that is perpendicular to the first direction, such as along the axis of the thermal process system. For example, elongated sections of the heating module may be arranged in parallel and connected via connecting sections that permit outward radial flexure to accommodate thermal expansion of the thermal process system. In these various ways, heating assemblies described herein may be efficient, reliable, and particularly suited to thermal processes systems in resource limited environments.

In some examples, the disclosure describes a heating assembly that includes at least two electrical connectors and at least one heating module extending between the at least two electrical connectors. Each heating module is monolithic and includes graphite, and is configured to expand in a first direction and remain rigid in a second direction that is perpendicular to the first direction.

In some examples, a method for forming a heating assembly includes machining a graphite substrate to form at least one heating module. Each heating module is monolithic and includes graphite, and is configured to expand in a first direction and remain rigid in a second direction that is perpendicular to the first direction. The method further includes attaching at least two electrical connectors to the at least one heating module, such that the at least one heating module extends between the at least two electrical connectors.

In some examples, the disclosure describes a thermal process system that includes a vessel configured to house one or more process gases and a heating assembly configured to heat the vessel. The heating assembly includes at least two electrical connectors and at least one heating module extending between the at least two electrical connectors. Each heating module is monolithic and includes graphite, and is configured to expand away from the vessel in a first direction and remain rigid along the vessel in a second direction that is perpendicular to the first direction.

The details of one or more examples are set forth in the accompanying drawings and the description below. Other features, objects, and advantages will be apparent from the description and drawings, and from the claims.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a cross-sectional side view diagram illustrating an example thermal process system configured to pyrolyze hydrocarbons.

FIG. 1B is a perspective view diagram illustrating the example thermal process system of FIG. 1A in partial disassembly.

FIG. 1C is a perspective view diagram illustrating an example heating assembly of the example thermal process system of FIG. 1A.

FIG. 1D is a block diagram illustrating an example thermal process system that includes a power circuit.

FIG. 2A is a side view diagram illustrating an example heating module of a heating assembly.

FIG. 2B is a side view diagram illustrating the example heating module of FIG. 2A.

FIG. 3 is a flowchart of an example technique for forming a heating assembly.

### DETAILED DESCRIPTION

In general, the disclosure describes heating assemblies, including methods of manufacture, that include one or more relatively high temperature (e.g., greater than about 850° C.) heating modules configured to efficiently heat a thermal process system and resist mechanical stresses exerted by components of the thermal process system.

Thermal process systems, such as systems for pyrolyzing hydrocarbons, may include heating assemblies that are configured to generate heat to maintain a substrate or process gas at a high temperature, such as for reactions or heat treatments. For example, some hydrocarbon pyrolysis reactors are configured to heat hydrocarbons to pyrolyze the hydrocarbons into solid carbon and hydrogen gas. To generate heat, heating elements of the heating assemblies may be subject to at least the high temperature of the substrate or process gases, and may undergo thermal cycling between high temperatures during operation and low temperatures outside of operation. As a result of these high and/or variable temperatures, the heating elements may experience oxidation or thermal stresses that may form cracks in the heating elements or otherwise change the structural integrity of the heating elements.

In a resource-limited environment, such as an aircraft, spacecraft, or submerged watercraft, long service life of heating elements may be particularly important, as replacement heating elements may take up space and require difficult repairs. Resistive heating elements that generate heat in response to electrical energy may be particularly robust and suited to thermal process systems in resource-limited environments. For example, some resistive heating elements include conductive materials, such as ceramics, that have high mechanical strength and are capable of generating heat through a Joule heating effect. However, resistive heating elements formed from ceramics may be particularly brittle and prone to cracking. Further, resistive heating elements may be dependent on electrical continuity of the heating element, such that a crack or other discontinuity may substantially reduce end-to-end electrical conductivity, and may require replacement of the entire heating assembly.

According to various examples described herein, heating assemblies include one or more high temperature heating modules configured to efficiently heat a thermal process system with reduced mechanical strain. A heating assembly includes at least two electrical connectors configured to receive power and at least one heating module between the electrical connectors. Each heating module is monolithic and includes graphite, which has a relatively high electrical conductivity compared to other non-metallic heating elements (e.g., ceramic). In some examples, each heating module includes elongated sections having a relatively small cross-section (e.g., compared to its length), and a corresponding high resistance, suitable for generating thermal energy sufficient to efficiently heat the thermal process system to a desired temperature.

The heating assembly may be configured to accommodate thermal expansion and contraction of adjacent components of the thermal process system, such as a vessel or housing in contact or close proximity to the heating assembly. In some examples, each heating module is configured to expand in a first direction, such as away from an axis of the thermal process system, and remain rigid in a second direction that is substantially perpendicular to the first direction, such as along the axis of the thermal process system. For example, elongated sections of the heating module may be aligned in parallel and connected in series via connecting sections that permit flexure away from the thermal process system to accommodate thermal expansion of the thermal process system. In some examples, the graphite of the heating modules have mechanical properties, such as Young's modulus, that permit the heating modules expand in response to a thermally-induced force on the heating modules without breakage. In these various ways, heating assemblies described herein may be efficient, reliable, and particularly suited to thermal processes systems in resource limited environments.

Heating assemblies described herein may be used in a variety of thermal process systems, such as methane pyrolysis reactors, that operate at high temperatures and/or experience high (e.g., frequent or high variation) thermal cycling loads. In some examples, thermal process systems described herein are configured to be utilized in aerospace applications, such as spacecraft. For example, a spacecraft may include a resource-limited and weight-and volume-sensitive environment for which resources like oxygen and water may be preserved in closed loop processes. The thermal process systems described herein may be used for various high temperature processes intended to preserve resources within this environment, such as a pyrolysis reactor for methane pyrolysis.

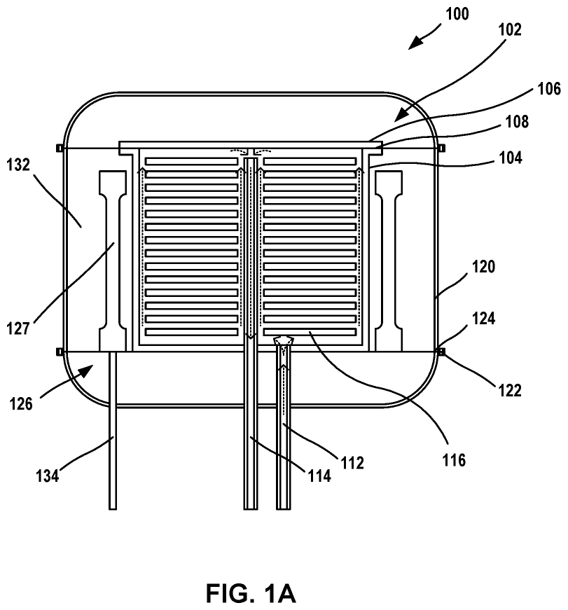

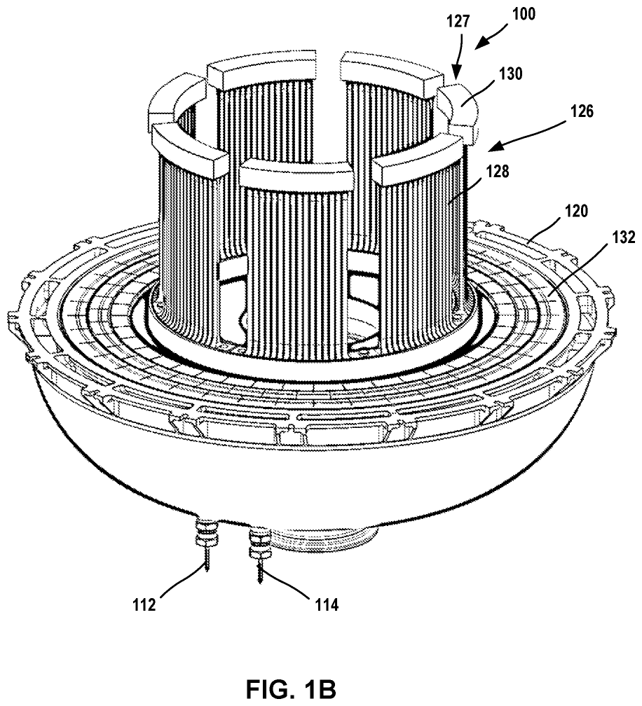

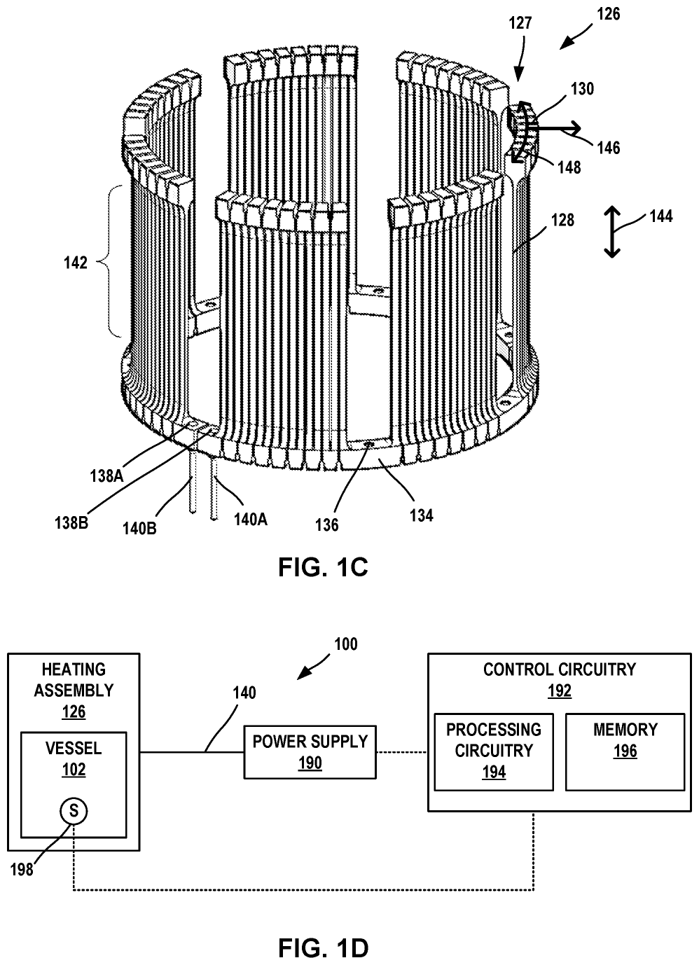

FIG. 1A is a cross-sectional side view diagram illustrating an example thermal process system 100, such as a pyrolysis reactor configured to be used to generate hydrogen gas from hydrocarbons. However, in other examples, thermal process system 100 may be used for reactions or heat treatments other than methane pyrolysis that proceed at high temperatures.

Thermal process system 100 includes a vessel 102. In the example of FIG. 1A, vessel 102 is a retort assembly that includes a vessel chamber 104 and a removable vessel lid 106; however, in other examples, vessel 102 has other forms and configurations, such as a vessel having a monolithic containment boundary. Vessel 102 is configured to substantially contain one or more process gases in vessel chamber 104 during a thermal process. For example, vessel chamber 104 and vessel lid 106 may define a process volume in which one or more process gases undergo a reaction or heat process.

Vessel 102 may have any of a variety of shapes, including relatively unconventional shapes for which customized thermal management devices may be used. In the example of FIG. 1A, vessel 102 is configured for general flow along an axis of vessel chamber 104, such that process gases, such as hydrocarbon gases, may be continuously received and product gases, such as hydrogen gas, reaction byproducts, and unreacted hydrocarbon gases, may be continuously discharged from thermal process system 100. Vessel 102 is configured to form a containment boundary for the one or more process gases in vessel chamber 104. Once positioned, vessel chamber 104 and vessel lid 106 are configured to contain the one or more process gases and substantially prevent (e.g., prevent or prevent to the extent permitted by manufacturing) the process gases from migrating from the vessel volume into another volume, or other gases from migrating into the vessel volume.

Thermal process system 100 includes one or more process gas inlets 112 configured to discharge an inlet gas mixture into vessel chamber 104 and one or more gas outlets 114 configured to receive an outlet gas mixture from vessel chamber 104. In the example of FIG. 1A, inlet 112 includes an opening at a first end of vessel chamber 104 configured to discharge the inlet gas mixture into vessel chamber 104, while outlet 114 includes an opening at a second, opposite end configured to receive gases from vessel chamber 104. As a result, gases may flow from process gas inlet 112 through the vessel volume within vessel chamber 104, including a substrate 116, and to gas outlet 114.

During a thermal process, such as a reaction, heating process, or inerting process, the process volume within vessel chamber 104 may be at relatively high temperatures. For example, for some methane pyrolysis, process gases within the process volume have a temperature greater than or equal to about 850° C. As such, vessel 102 may be configured for exposure to relatively high temperatures. In some examples, each of vessel lid 106 and vessel chamber 104 includes non-metallic materials, such as graphite, a ceramic, or a ceramic matrix composite. Non-metallic materials may be stronger and more resistant to creep, corrosion, instabilities, or other high temperature structural defects than metals. Provided acceptable high-temperature strength and toughness, the properties of interest for materials of vessel 102 may include, but are not limited to: reduced density, such as to reduce weight; increased chemical compatibility with gases, such as methane and hydrogen, at high temperatures; thermal stability; thermal conductivity; hardness, such as to increase robustness and/or dimensional stability; manufacturability; and the like.

In some examples, such as the example of FIG. 1A, thermal process system 100 includes an additional vessel housing 120 positioned around vessel 102 and one or more heating rods 128. Vessel housing 120 is configured to maintain a pressure within vessel 102 by forming a pressure boundary for one or more gases in vessel 102. Materials used for vessel housing 120 may be selected for relatively low weight, such as aluminum. In some examples, vessel housing 120 is configured in two or more sections to at least partially disassemble to access one or more components within vessel housing 120. In the example of FIG. 1A, vessel housing 120 includes sections, such as a top end cap, a body, and a bottom end cap. Adjacent sections of vessel housing 120 may be attached using one or more connectors 122 and hermetically sealed against each other using one or more seals 124 positioned at an interface between adjacent sections of vessel housing 120. For example, connectors 122 may include bolts or other fasteners, and seals 124 may include one or more O-rings.

Thermal process system 100 may include various thermal retention materials surrounding vessel chamber 104 and/or vessel lid 106 and configured to retain heat within vessel chamber 104. In some examples, thermal process system 100 includes thermal insulation materials configured to reduce thermal conductive losses from vessel chamber 104. In the example of FIG. 1A, thermal process system 100 includes insulation 132 surrounding vessel chamber 104 and one or more heating rods 128 of a heating assembly 126. In some examples, insulation 132 includes solid insulation material, such as a solid microporous ceramic insulation material capable of working temperatures up to about 1200° C.

Thermal process system 100 includes a heating assembly 126 configured to heat vessel 102 and, correspondingly, heat one or more process gases within vessel chamber 104. Heating assembly 126 includes at least one heating module 127 positioned around vessel chamber 104. In some examples, electrical connectors 134 configured to provide energy to heat assembly 126 are positioned opposite vessel lid 106 or through other interfaces that may not interfere with removal of lid 106 from vessel chamber 104. Electrical connectors 134 may be configured to directly or indirectly electrically couple to a power source, such as an alternating current (AC) or direct current (DC) power source. Heating assembly 126 will be described further in FIG. 1B below.

While thermal process system 100 of FIG. 1A has been described with respect to vessel 102 surrounded by insulation 132 and vessel housing 120, in other examples, a thermal process system used with heating assemblies described herein may include a single vessel for which heating assembly 126 is in direct or indirect thermal contact with a process gas or substrate. For example, vessel 102 may be a hot-wall reactor or include heating assembly 126 as an internal system.

FIG. 1B is a perspective view diagram illustrating the example thermal process system 100 of FIG. 1A in partial disassembly and including heating assembly 126. Heating assembly 126 includes at least one heating module 127. In the example of FIG. 1B, heating assembly 126 includes six heating modules 127; however, heating assembly 126 may include any number of heating modules 127. Heating modules 127 are spatially configured (e.g., arranged and positioned) such that heating modules 127 deliver heat to an adjacent object or volume. In the example of FIG. 1B, heating modules 127 deliver heat to a wall of vessel chamber 104, such that heating assembly 126 is configured in a circular arrangement around vessel 102 to heat vessel 102. That is, a plurality of heating modules 127 are arranged in a circular pattern. However, in other examples, heating assembly 126 may be spatially configured to heat other volumes or objects, such as a heating assembly that includes heating rods in a linear arrangement configured to heat a planar surface of a substrate.

Each heating module 127 includes a plurality of elongated sections 128 and a plurality of interconnecting sections 130 between two adjacent elongated sections 128. Each elongated section 128 is configured to receive applied electrical energy and generate heat in response to the applied electrical energy. In the example of FIG. 1B, heating assembly 126 is configured to generate heat in a bulk of elongated sections 128 and transfer the heat from a surface of elongated section 128 to heat a wall of vessel 102 and, correspondingly, a process gas within vessel 102. The heat generated by elongated sections 128 may be transferred to a substrate or object using any suitable heating mechanism including conductive heat transfer, convective heat transfer, or radiative heat transfer.

Each elongated section 128 is electrically and mechanically coupled to at least one interconnecting section 130. Correspondingly, each interconnection section 130 is coupled to at least one elongated section 128 and is configured to transfer electrical energy to or from elongated section 128. In addition to being coupled to an elongated section 128, each interconnecting section 130 is coupled to either an electrical connector (e.g., electrical connector 140, not shown in FIG. 1B) or another elongated section 128.

In operation, to heat vessel 102, control circuitry (e.g., shown in FIG. 1D) may control a power source (e.g., shown in FIG. 1D) to deliver electrical energy to heating assembly 126. Heating assembly 126 may receive the electrical energy, such as from electrical connector 134 of FIG. 1A. The electrical energy may have particular electrical properties, such as voltage and current, that cause elongated sections 128 to generate a particular amount of heat. The generated heat may transfer from elongated section 128 to a wall of vessel 102 to heat one or more process gases in vessel 102. The various parameters of the electrical energy may be configured to cause elongated sections 128 to generate heat sufficient to heat the process gases in vessel 102 to a particular temperature, such as a reaction or heat treatment temperature.

FIG. 1C is a perspective view diagram illustrating an example heating assembly 126 of the example thermal process system 100 of FIG. 1A. Heating assembly 126 includes at least one heating module 127 extending between electrical connectors 140A and 140B. Each heating module 127 may be a functional heating unit configured to generate heat in response to application of electrical energy to heating module 127. In some examples, each heating module 127 emit a relatively uniform heat flux, such that substantial variation (e.g., greater than 50 percent) of heat flux may indicate differentiation between adjacent heating modules 127. In some examples, heating assembly 126 includes at least two heating modules 127 electrically coupled together between electrical connectors 140. In the example of FIG. 1C, heating assembly 126 include seven heating modules 127 arranged and distributed around an axis of heating assembly 126; however, heating assemblies described herein may include any number of heating modules.

In some examples, as shown in FIG. 1C, heating assembly 126 includes one or more spacer sections 134. Each spacer section 134 may be configured to space apart adjacent heating modules 127. In some examples, at least one spacer section 134 includes a locating hole 136. Locating hole 136 may be configured to secure heating assembly 126 to a vessel or vessel housing, such as housing 120 of FIG. 1B.

Heating assembly 126 defines a conductive path for electrical energy that includes a heating module 127 at a first end and a same (e.g., for heating assemblies that include a single heating module 127) or different (e.g., for heating assemblies that include multiple heating modules 127) heating module 127 at a second end. Heating assembly 126 includes at least two electrical connectors 140A and 104B (collectively, “electrical connectors 140”). Each electrical connector 140 is configured to electrically couple to a power circuit to deliver electrical power through heating assembly 126.

Electrical connectors 170 can be electrically connected to heating assembly 126 using any suitable technique. In some examples, as shown in FIG. 1C, a heating module 127 at the first end of heating assembly 126 may include a first connecting hole 138A, and a heating module 127 at a second end of heating assembly 126 may include a second connecting hole 138B. The at least two electrical connectors 140A and 140B are positioned in a respective first or second connecting hole 138A or 138B.

Each heating module 127 is monolithic, such that electrical energy may travel through heating module 127 without encountering an interface between two dissimilar materials or microstructures. For example, each heating module 127 may be formed from a substrate through a subtractive manufacturing process that preserves a uniform microstructure of the substrate. In some examples, heating assembly 126 may include two or more heating modules 127 that are monolithic and formed from the same substrate. In the example of FIG. 1C, all seven heating modules 127 are formed from a same substrate.

Heating assembly 126 may include heating modules 127 arranged in any of a variety of patterns or configurations. In the example of FIG. 1C, heating modules 127 are arranged in a circular pattern and configured to expand radially outward. However, in other examples, heating modules 127 may be aligned in a linear configuration and configured to expand along an axis of the linearly-arranged heating modules 127.

Each heating module 127 includes graphite. Graphite has high thermal stability and chemical resistance for operating within a high temperature oxidative environment. Additionally, graphite has mechanical and electrical properties that enable heating assembly 126 to accommodate expansion of a vessel within heating assembly 126 and generate heat for heating the vessel within heating assembly 126. For example, graphite may have a flexural strength of greater than or equal to about 55 megapascal (MPa), a Young's modulus of greater than or equal to about 11 gigapascal (GPa), and an electrical resistivity of less than or equal to about 1000 microohm (μΩ)/centimeter (cm). The mechanical properties of graphite may provide greater flexure to heating modules 127 than ceramics, such as silicon carbide, that may reduce cracking or other changes to structural integrity, and the electrical properties of graphite may provide greater resistivity to heating modules 127 than metals or metal alloys, such as a nickel-chromium alloy, yet greater conductivity to heating modules 127 than ceramics.

Each heating module 127 is configured to expand in a first direction 148 and remain rigid in a second direction 144 that is perpendicular to first direction 148. Substantially perpendicular arrangement may be, for example, within about 1-10 degrees, such as about 1-5 or 5 degrees, of perpendicular. In a circular arrangement of heating modules 127 illustrated in FIG. 1C, first direction 148 may be a circumferential direction of expansion that translates to an outward radial direction 146, such that heating module 127 expands away from a vessel or other target structure within or adjacent to heating assembly 126. Expansion of heating module 127 in first direction 148 may result from a combination of material properties of graphite and structural properties of heating module 127, as described below.

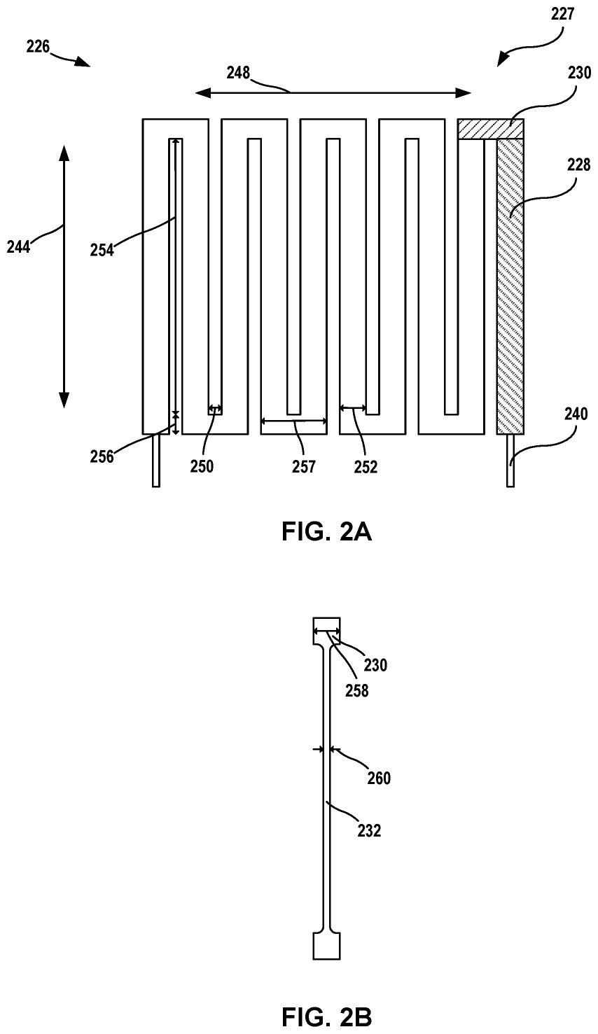

In the example shown in FIG. 1C, each heating module 127 defines a plurality of elongated sections 128 and a plurality of interconnecting sections 130 between two adjacent elongated sections 128. Each of the plurality of elongated sections 128 defines a major dimension that is aligned along second direction 144. Each interconnecting section 130 is configured to permit relative movement between adjacent elongated sections 128. For example, as will be described in FIGS. 2A-2C below, interconnecting sections 130 may be sized and shaped such that adjacent elongated sections 128 may expand relative to each other in response to an expansive radial force against heating assembly 126. While interconnecting sections 130 are illustrated as having a substantially large volume, in some examples, interconnecting sections 130 may be smaller, such as having substantially similar dimensions as elongated sections 128 (e.g., thickness).

Each elongated section 128 is configured to remain rigid in response to the expansive radial force and generate heat in response to electrical energy. For example, as will be described in FIGS. 2A-2C below, elongated sections 128 may be sufficiently small to provide high electrical resistivity. In some examples, an electrical resistivity of a heating module 127 is from about 1 ohm to about 5 ohms.

Heating assemblies described herein may be controlled by a power circuit. FIG. 1D is a block diagram illustrating an example thermal process system 100 that includes a power circuit, including a power supply 190 and control circuitry 192, configured to power a heating assembly 126. While described functionally as discrete units, power supply 190 and control circuitry 192 may be configured in any functional arrangement, including as a single unit or more than two units.

Power supply 190 is configured to supply electrical energy to heating assembly 126 through electrical connector 140. Power supply 190 is communicatively coupled to control circuitry 192 and configured to control electrical parameters of the electrical energy based on control signals from control circuitry 192. For example, power supply 190 may be configured to receive a control signal from control circuitry 192 that indicates a desired power level and/or set of electrical parameters and generate and deliver electrical energy having a particular voltage and/or current (or range of voltages and/or currents) corresponding to a desired power level and/or set of electrical parameters indicated by the control signal.

Control circuitry 192 is configured to control power supply 190 to supply the electrical energy to heating assembly. In the example of FIG. 1D, control circuity 192 is communicatively coupled to power supply 190 and one or more sensors 198 within vessel 102, such as temperature and/or pressure sensors. Control circuitry 192 may be configured to send control signals to power supply 190 indicating a power level or set of electrical parameters. Control circuitry 192 may be configured to receive measurement signals from sensors 198, such as temperature measurement signals indicating a temperature within vessel 102. For example, control circuitry 192 may be configured to receive a temperature signal that indicates a temperature of one or more process gases within vessel 102 or a substrate exposed to heating assembly 126. In some examples, control circuitry 192 is configured to control heating assembly 126 based on temperature measurement signals received from sensors 198.

Control circuitry 192 includes processing circuitry 194 and memory 196. Processing circuitry 194 may be configured to execute control algorithms that define a particular heating profile in terms of respective values for electrical parameters delivered by power supply 190 to heating assembly 126, such as duty cycle, current or voltage amplitude, and/or frequency. Processing circuitry 194 may include any one or more microprocessors, controllers, digital signal processors (DSPs), application specific integrated circuits (ASICs), field-programmable gate arrays (FPGAs), or equivalent discrete or integrated digital or analog logic circuitry, and the functions attributed to processing circuitry 194 herein may be embodied as software, firmware, hardware, or any combination thereof. Memory 196 includes computer-readable instructions that, when executed by processing circuitry 194, causes control circuitry 192 to perform various functions, such as control algorithms. Memory 196 may include any volatile, non-volatile, magnetic, optical, or electrical media, such as a random-access memory (RAM), read-only memory (ROM), non-volatile RAM (NVRAM), electrically-erasable programmable ROM (EEPROM), flash memory, or any other digital media.

Power circuits, such as power supply 190 and/or control circuitry 192, coupled to a heating assembly (e.g., of system 100) that includes monolithic heating modules that include graphite may be configured to operate more efficiently than power circuits coupled to a heating assembly that includes heating elements made from materials having higher electrical conductivity. For example, power supply 190 may be configured to supply electrical energy having a higher voltage and lower current (or a lower voltage and a higher current) for a particular power level. As a result of this reduced current, power supply 190 and control circuitry 192 may operate more efficiently. In some examples, a lower current may reduce a cross-sectional area of electrical connector 140 and, correspondingly, reduce a gap in insulation for accommodating electrical connector 140.

FIG. 2A is a side view diagram illustrating an example heating module 227 of a heating assembly 226, while FIG. 2B is a side view diagram illustrating the example heating module of FIG. 2A. Heating module 227 is an example of heating module 127 of FIGS. 1A-IC. Components of heating assembly 226 may correspond to similarly named and numbered (e.g., 2XX to 1XX) components of heating assembly 126 of FIGS. 1A-ID In the example of FIG. 2A, heating assembly 226 is illustrated as including only one heating module 227 extending between two electrical connectors 240. Heating module 227 is configured to expand in a first direction 248 and remain rigid in a second direction 244 that is substantially perpendicular to first direction 248.

Heating module 227 defines a plurality of elongated sections 228 and a plurality of interconnecting sections 230 between two adjacent elongated sections 228. Each of the plurality of elongated sections 228 is aligned along second direction 244. As explained above with respect to heating module 127 in FIG. IC, heating module 227 is monolithic, such that elongated section 228 and interconnecting sections 230 may be functional sections of heating module 127 that are differentiated by a difference in one or more dimensions.

Each interconnecting section 230 is coupled to two adjacent elongated sections 228, and is configured to permit a degree of flexure between the two adjacent elongated sections 228. Such flexure may be sufficient to accommodate any thermal expansion of the housing to which heating assembly 226 is attached during a thermal process. In some examples, to support the flexure between the adjacent elongated sections 228 and/or to provide a surface for contacting a housing or other structure, interconnecting section 228 may have a substantially greater cross-section across second direction 244 than the adjacent elongated sections 228. In other examples, interconnecting section 228 may not have a substantially greater cross-section across second direction 244. Each interconnecting section 230 has a length 256 representing a maximum dimension of elongated section 228 along second direction 244, a width 257 representing a maximum dimension of elongated section 228 along first direction 246, and a thickness 258 representing a maximum dimension of elongated section 228 substantially perpendicular to both first direction 246 and second direction 244. Length 256 and thickness 258 may be selected to support heating module 227 within a housing to reduce contact with other components and/or resist fracture of interconnecting section 230 in response to an expansive force on heating module 227 causing flexure between the adjacent elongated sections 228.

The plurality of elongated sections 228 of heating module 227 define a heating surface area for heat flux to emit toward a target vessel or other structure. Adjacent elongated sections 228 may be separated by a gap 250. Gap 250 may large enough to maintain electrical isolation between adjacent elongated sections 228 and small enough to maintain a high surface area for heat flux from heating module 227. Each elongated section 228 has a width 252 representing a maximum dimension of elongated section 228 along first direction 246, a length 254 representing a maximum dimension of elongated section 228 along second direction 244, and a thickness 260 representing a maximum dimension of elongated section 228 substantially perpendicular to both first direction 246 and second direction 244. Elongated section 228 may have a substantially elongated shape, such that length 254 is substantially greater than width 252 and thickness 260. For example, length 254 may be at least ten times greater than width 252 and thickness 260. Width 252 and thickness 260 may be selected for a variety of factors including mechanical strength, heat dispersal, conductive cross-sectional area, or other factors related to mechanical strength or heat generation or distribution of elongated section 228.

Width 252 and thickness 260 may be selected to provide a small cross-sectional area to elongated section 228. For example, resistance may be represented with the following equation:

$$R = ρ ( \frac{L}{A} )$$

In the above equation, R represents resistance, p represents resistivity of graphite, L represents an average path length of current through heating module 227, and A represents an average cross-sectional area of elongated section 228. As a cross-sectional area (A) of elongated section 228 decreases, an electrical resistivity (R) increases, thereby producing a greater amount of heat in response to a given electrical energy level. As such, heating module 227 may be configured to have a high ratio of length (L) to cross-sectional area (A) to increase the resistance (R) of heating module 227. Such resistance drives the operating voltages higher, and overall system efficiency goes up with higher voltages. Heating modules 227 having elongated sections 228 have a very high L/A ratio, such as compared to other non-metallic heating elements. For example, heating module 227 may have a ratio of L/A of equal to or greater than about 40,000/centimeter (cm), such as equal to or greater than as high as 120,000/cm. In contrast, cylindrical heating elements used in HIP furnaces that include other non-metallic materials may have a ratio of L/R of between about 400/cm to about 1200/cm. In some examples, thickness 260 may be from about 1 millimeter to about 1 centimeter. By configuring heating module 227 with elongated sections 228 having a small cross-sectional area, sufficient Joule heat may be generated without high currents or low voltages. Additionally, heating module 227 may have this high efficiency while operating as a robust free standing structure with extremely high L/A ratios.

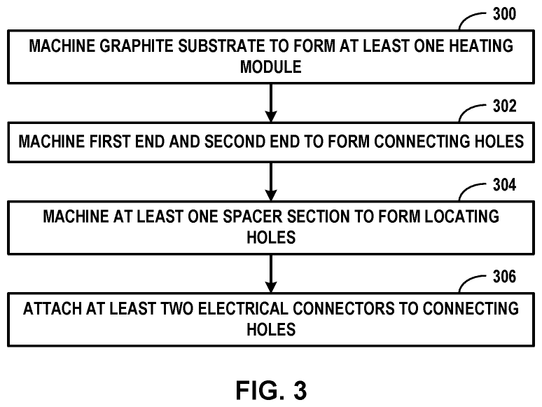

In some examples, heating assemblies described herein are formed through subtractive manufacturing processes. FIG. 3 is a flowchart of an example technique for forming a heating assembly, and will be described with respect to heating assembly 126 of FIG. IC.

The technique of FIG. 3 includes machining a graphite substrate to form at least one heating module 127 (300), such that heating module 127 is monolithic and includes graphite. For example, the graphite substrate may be formed as a ring having a height that corresponds to a height of heating modules 127 and a thickness that corresponds to a thickness of heating modules 127. A variety of machining processes may be used including, but not limited to, cutting, grinding, drilling, or any other subtractive process that mechanically or thermally removes graphite from the graphite substrate. The graphite substrate may be machined to form a plurality of elongated sections and a plurality of interconnecting sections 128 between two adjacent elongated sections 130, for which each of the plurality of elongated sections 128 is aligned along second direction 144. For heating assemblies 126 that include more than one heating module 127, machining the graphite substrate to form at least one heating module may include machining the graphite substrate to form a spacer section 134 between adjacent heating modules 127.

The technique of FIG. 3 further includes machining the graphite substrate to form a first connecting hole 138A in a heating module at a first end of heating assembly 126 and a second connecting hole 138B in a heating module 127 at a second end of heating assembly 126 (302). The technique of FIG. 3 may include machining at least one spacer section 134 to form a locating hole 136 configured to secure heating assembly 126 to a vessel or vessel housing (304). The technique of FIG. 3 may include attaching at least two electrical connectors 140 to the connecting holes 138A and 138B (306), such that the heating modules 127 of heating assembly 126 extend between the at least two electrical connectors 140, such as by inserting an electrical connector 140 into a respective first or second connecting hole 138A or 138B.

The following numbered examples may demonstrate one or more aspects of the disclosure.

Example 1: A heating assembly includes at least two electrical connectors; and at least one heating module extending between the at least two electrical connectors, wherein each heating module is monolithic and comprises graphite, and wherein each heating module is configured to expand in a first direction and remain rigid in a second direction that is substantially perpendicular to the first direction.

Example 2: The heating assembly of example 1, wherein each heating module defines a plurality of elongated sections and a plurality of interconnecting sections between two adjacent elongated sections, and wherein each elongated section of the plurality of elongated sections is aligned along the second direction.

Example 3: The heating assembly of example 2, wherein the plurality of elongated sections have a thickness from about 1 millimeter to about 1 centimeter.

Example 4: The heating assembly of any of examples 2 and 3, wherein a ratio of an average path length of the at least one heating module to an average cross-sectional a rea of the plurality of elongated sections is equal to or greater than about 40,000/centimeter.

Example 5: The heating assembly of any of examples 1 through 4, wherein the at least one heating module comprises a plurality of heating modules arranged in a circular pattern.

Example 6: The heating assembly of any of examples 1 through 5, wherein the at least one heating module comprises at least two heating modules electrically coupled together between the at least two electrical connectors.

Example 7: The heating assembly of example 6, wherein the at least two heating modules are monolithic.

Example 8: The heating assembly of any of examples 6 and 7, wherein adjacent heating modules of the at least two heating modules are spaced apart by a spacer section.

Example 9: The heating assembly of example 8, wherein at least one spacer section includes a locating hole configured to secure the heating assembly to a vessel.

Example 10: The heating assembly of any of examples 1 through 9, wherein the at least one heating module comprises a first connecting hole at a first end and a second connecting hole at a second end, and wherein the at least two electrical connectors are positioned in a respective first or second connecting hole of the at least one heating module.

Example 11: A method for forming a heating assembly includes machining a graphite substrate to form at least one heating module, wherein each heating module is monolithic and comprises graphite, and wherein each heating module is configured to expand in a first direction and remain rigid in a second direction that is substantially perpendicular to the first direction; and attaching at least two electrical connectors to the at least one heating module, wherein the at least one heating module extends between the at least two electrical connectors.

Example 12: The method of example 11, wherein each heating module defines a plurality of elongated sections and a plurality of interconnecting sections between two adjacent elongated sections, and wherein each elongated section of the plurality of elongated sections is aligned along the second direction.

Example 13: The method of any of examples 11 and 12, wherein the at least one heating module comprises at least two heating modules electrically coupled together between the at least two electrical connectors.

Example 14: The method of example 13, wherein the at least two heating modules are monolithic.

Example 15: The method of any of examples 13 and 14, wherein machining the graphite substrate comprises: machining the graphite substrate to a spacer section between adjacent heating modules of the at least two heating modules, and machining at least one spacer section to form a locating hole configured to secure the heating assembly to a vessel.

Example 16: The method of any of examples 11 through 15, wherein machining the graphite substrate comprises machining a first connecting hole at a first end of the at least one heating module and a second connecting hole at a second end of the at least one heating module, and wherein attaching the at least two electrical connectors comprises inserting an electrical connector of the at least two electrical connectors into a respective first or second connecting hole of the at least one heating module.

Example 17: A thermal process system includes a vessel configured to house one or more process gases; and a heating assembly configured to heat the vessel, wherein the heating assembly comprises: at least two electrical connectors; and at least one heating module extending between the at least two electrical connectors, wherein each heating module is monolithic and comprises graphite, and wherein each heating module is configured to expand in a first direction and remain rigid in a second direction that is substantially perpendicular to the first direction.

Example 18: The thermal process system of example 17, wherein each heating module defines a plurality of elongated sections and a plurality of interconnecting sections between two adjacent elongated sections, and wherein each elongated section of the plurality of elongated sections is aligned along the second direction.

Example 19: The thermal process system of any of examples 17 and 18, wherein the at least one heating module comprises at least two heating modules electrically coupled together between the at least two electrical connectors.

Example 20: The thermal process system of any of examples 17 through 19, wherein the thermal process system includes a methane pyrolysis reactor.

Various examples have been described. The various examples can be used together in any suitable combination. These and other examples are within the scope of the following claims.

What is claimed is:

1. A heating assembly, comprising:
at least two electrical connectors; and
at least one heating module extending between the at least two electrical connectors,
wherein each heating module is monolithic and comprises graphite, and
wherein each heating module is configured to expand in a first direction and remain rigid in a second direction that is substantially perpendicular to the first direction.

2. The heating assembly of claim 1,
wherein each heating module defines a plurality of elongated sections and a plurality of interconnecting sections between two adjacent elongated sections, and
wherein each elongated section of the plurality of elongated sections is aligned along the second direction.

3. The heating assembly of claim 2, wherein the plurality of elongated sections have a thickness from about 1 millimeter to about 1 centimeter.

4. The heating assembly of claim 2, wherein a ratio of an average path length of the at least one heating module to an average cross-sectional area of the plurality of elongated sections is equal to or greater than about 40,000/centimeter.

5. The heating assembly of claim 1, wherein the at least one heating module comprises a plurality of heating modules arranged in a circular pattern.

6. The heating assembly of claim 1, wherein the at least one heating module comprises at least two heating modules electrically coupled together between the at least two electrical connectors.

7. The heating assembly of claim 6, wherein the at least two heating modules are monolithic.

8. The heating assembly of claim 6, wherein adjacent heating modules of the at least two heating modules are spaced apart by a spacer section.

9. The heating assembly of claim 8, wherein at least one spacer section includes a locating hole configured to secure the heating assembly to a vessel.

10. The heating assembly of claim 1,
wherein the at least one heating module comprises a first connecting hole at a first end and a second connecting hole at a second end, and
wherein the at least two electrical connectors are positioned in a respective first or second connecting hole of the at least one heating module.

11. A method for forming a heating assembly, comprising:
machining a graphite substrate to form at least one heating module, wherein each heating module is monolithic and comprises graphite, and wherein each heating module is configured to expand in a first direction and remain rigid in a second direction that is substantially perpendicular to the first direction; and
attaching at least two electrical connectors to the at least one heating module, wherein the at least one heating module extends between the at least two electrical connectors.

12. The method of claim 11,
wherein each heating module defines a plurality of elongated sections and a plurality of interconnecting sections between two adjacent elongated sections, and
wherein each elongated section of the plurality of elongated sections is aligned along the second direction.

13. The method of claim 11, wherein the at least one heating module comprises at least two heating modules electrically coupled together between the at least two electrical connectors.

14. The method of claim 13, wherein the at least two heating modules are monolithic.

15. The method of claim 13, wherein machining the graphite substrate comprises:
machining the graphite substrate to a spacer section between adjacent heating modules of the at least two heating modules, and
machining at least one spacer section to form a locating hole configured to secure the heating assembly to a vessel.

16. The method of claim 11,
wherein machining the graphite substrate comprises machining a first connecting hole at a first end of the at least one heating module and a second connecting hole at a second end of the at least one heating module, and
wherein attaching the at least two electrical connectors comprises inserting an electrical connector of the at least two electrical connectors into a respective first or second connecting hole of the at least one heating module.

17. A thermal process system comprising:
a vessel configured to house one or more process gases; and
a heating assembly configured to heat the vessel, wherein the heating assembly comprises:
at least two electrical connectors; and
at least one heating module extending between the at least two electrical connectors,
wherein each heating module is monolithic and comprises graphite, and
wherein each heating module is configured to expand in a first direction and remain rigid in a second direction that is substantially perpendicular to the first direction.

18. The thermal process system of claim 17,
wherein each heating module defines a plurality of elongated sections and a plurality of interconnecting sections between two adjacent elongated sections, and
wherein each elongated section of the plurality of elongated sections is aligned along the second direction.

19. The thermal process system of claim 17, wherein the at least one heating module comprises at least two heating modules electrically coupled together between the at least two electrical connectors.

20. The thermal process system of claim 17, wherein the thermal process system includes a methane pyrolysis reactor.
